(19) United States
(12) Patent Application Publication
(10) Pub. No.: US 2008/0202019 A1
(43) Pub. Date: Aug. 28, 2008

(54) Edge Protector For Wire Mesh Enclosure

(76) Inventor: Mark F. Brooks, Cushing, ME (US)

Correspondence Address: BOHAN MATHERS, PO BOX 17707, PORTLAND, ME, 04112-8707, US

(21) Appl. No.: 12/031,876

(22) Filed: Feb. 15, 2008

Related U.S. Application Data
(60) Provisional application No. 60/901,483, filed on Feb. 15, 2007.

(51) Int. Cl. A01K 69/06; B65D 6/08; B65D 25/26; A01K 69/08

(52) U.S. Cl. 43/60; 220/485; 220/655; 43/100

(57) ABSTRACT

Edge protector for protecting the edge of a lobster trap or other type of wire-mesh enclosure. The edge protector is a split tube with transverse openings cut into it at intervals that correspond to intersecting bars of a mesh material. The tube snaps over one bar and the intersecting bars extend outward through the transverse openings. The edge protector serves as a shock-absorbing bumper, prevents deformation of the wire-mesh enclosure, and also prevents damage to the plastic coating that protects the wire mesh.

### BACKGROUND INFORMATION

1. Field of the Invention

The invention relates to the field of edge protectors. More particularly, the invention relates to edge protectors for wire baskets or cages.

2. Discussion of the Prior Art

Wire mesh enclosures are used for many different purposes and are widely used in the fishing industry as lobster traps. The conventional lobster trap is a rectangular mesh cage that is stackable. Lobster traps are routinely subjected to rough handling. They are banged around a lot in the normal course of operations, being hauled over the sides of a boat, dragged along the seabed, stacked on top of each other for storage, and generally exposed to harsh elements of a salt-water environment. The wire mesh is typically encased in a plastic sheath, to prevent the mesh from rusting. Nevertheless, because of the rough treatment, the sheathing gets damaged and the wire the mesh rusts. The traps become deformed over time and no longer stackable.

The lobster trap represents a significant investment for the lobsterman and, as such, it is desirable to protect the traps from premature deterioration. It is also desirable that the traps maintain their rectangular shape, so that they are readily stackable. Understandably, the edges of the rectangular mesh enclosure take the most beating.

What is needed, therefore, is a means of protecting a wire mesh enclosure against deformation. What is further needed is such a means of protecting the protective sheathing on the wire mesh enclosure.

### BRIEF SUMMARY OF THE INVENTION

The present invention is an edge protector or bumper for a wire mesh enclosure, such as a lobster trap. The following discussion and illustrative examples refer to a lobster trap. It is understood, however, that the edge protector of the present invention is adaptable for use on wire mesh enclosures in general.

The conventional lobster trap is made of a wire mesh, which may or may not be encased in a protective plastic material. Protecting the edges of the enclosure from damage will significantly extend its useful life. The purpose of the edge protector is to minimize the deformation of the mesh structure that typically results from the rugged use to which lobster traps are subjected and to extend the life of the cage by preventing damage to the protective coating on the wire mesh.

The edge protector comprises a tubing that has been adapted to snap over a portion of the wire mesh, to serve as a bumper. It is understood, of course, that the tubing may be produced by various methods. For example, the tubing may be an extruded tubing, with the transverse grooves or openings subsequently cut into the tubing. The tubing may also be injection molded, in lengths that correspond to the dimensions of the lobster cage walls, whereby the transverse grooves are structurally integrated into the mold. The transverse grooves are spaced apart to correspond to the mesh size of the wire mesh. The tubing snaps over a horizontal or a vertical bar, whereby the transverse grooves accommodate the bars that extend transversely to the bar that carries the tubing. This effectively provides a type of bumper. Ideally, the edge protector is snapped along the bars that define the ends of the walls of the rectangular wire mesh enclosure, such that the outer boundary edges of the rectangular cage are protected, as these are the edges that take the most beating.

### BRIEF DESCRIPTION OF THE DRAWINGS

The present invention is described with reference to the accompanying drawings. In the drawings, like reference numbers indicate identical or functionally similar elements. The drawings are not to scale.

FIG. 1 is a perspective view of the edge protector according to the invention.

FIG. 2 is a planar view of the edge protector, illustrating a series of openings.

FIG. 3 is a cross-sectional view of the tubing.

FIG. 4 is a view of the edge protectors attached to a lobster trap.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

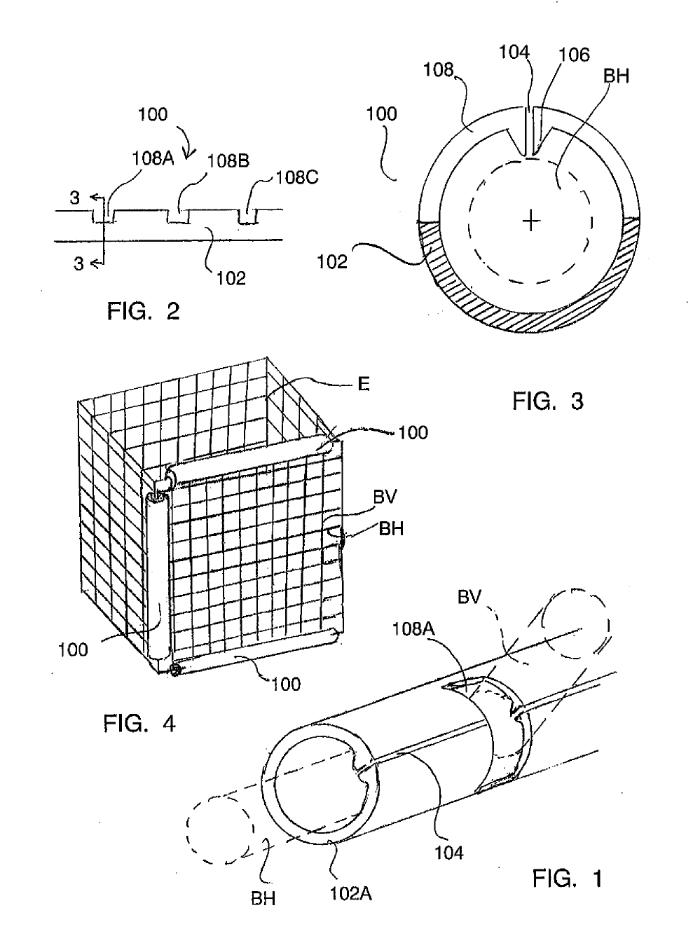

FIGS. 1-4 illustrate an edge protector 100 according to the invention, which is a hollow tube 102 that has been adapted to snap onto mesh bars B of a wire mesh enclosure E. FIG. 4 shows the edge protector 100 mounted on a horizontal and on a vertical edge of the wire mesh enclosure E. The wire mesh enclosure E is constructed of intersecting bars B. In the embodiment shown, the intersecting bars include horizontal bars BH and vertical bars BV that intersect with each other to form an evenly spaced grid. It is understood, that other configurations of intersecting bars are also possible. The tube 102 has a tube wall 102A and a snap groove 104 which is designed to snap over the bar B.

FIG. 2 is planar view of a length of the edge protector 100 and FIG. 3 a cross-sectional view. A series of openings 108, individually designated 108A, 108B, 108C, etc., are cut approximately halfway through the tube 102 on the side of the tube that has the groove 104. The groove 104 is a lengthwise split in the tube 102, with a thickening or protrusion 106 along each inner edge of the groove 104. The wall 102A has some flex to it, allowing the tube 102 to snap around the bar B when the groove 104 is pressed with sufficient force against the bar B.

FIG. 4 shows the edge protector 100 fitted onto the lobster trap E. The lobster strap E is only schematically represented. Indeed, the edge protector 100 can be used to protect any type of rectangular wire cage. The openings 108A, B, C are cut along the tube 102 at intervals that correspond to the mesh size and configuration. Assuming the edge protector 100 is used to protect the lower horizontal edge of a lobster trap, the edge protector 100 is aligned with the horizontal bar BH, with the vertical bars BV lined up with the openings 108 and the groove 104 facing the horizontal bar BH. Pressing the tube 102 against the horizontal bar BH will snap it over the bar. The protrusions 106 along the groove 104 serve to stiffen the edge of the groove 104 and to deflect any forces applied to them from the inside away from the groove 104, thereby reducing the likelihood that the edge protector 100 will snap off the bar B when the lobster trap E is subjected to impact shocks.

The edge protector 100 is made of any suitable shock-absorbing material, for example, polyvinyl chloride (PVC), natural or synthetic hard rubber, or other materials that have sufficient flexure to snap onto the enclosure E, can withstand compression and shear forces, and, if used as a bumper on lobster traps, will not deteriorate in saltwater or other harsh environments.

It is understood that the embodiments described herein are merely illustrative of the present invention. Variations in the construction of the edge protector may be contemplated by one skilled in the art without limiting the intended scope of the invention herein disclosed and as defined by the following.

What is claimed is:

1. An edge protector for attaching to a wire mesh enclosure that is constructed of intersecting bars that extend in a first direction and in a second direction that intersects with said intersecting bars that extend in said first direction, said edge protector comprising a tube having a longitudinal axis and a snap groove that extends parallel to said longitudinal axis and that splits said tube, said tube further having a plurality of transverse openings that extend across said snap groove, wherein said tube is assemblable on said intersecting bars that extend in said first direction and wherein said transverse openings are adapted to accommodate said intersecting bars that extend in said second direction.

2. The edge protector of claim 1, wherein said snap groove has a two edges, each edge having a protrusion that extends inward into said tube.

3. The edge protector of claim 1, wherein said tube is made of polyvinyl chloride.

4. A wire mesh enclosure comprising:
a body constructed of a wire mesh having intersecting bars that extend in a first direction and in a second direction that intersects with said intersecting bars that extend in said first direction, said body having boundary edges; and
at least one edge protector assembled on at least one of said boundary edges, said edge protector comprising a tube having a longitudinal axis and a snap groove that extends parallel to said longitudinal axis and that splits said tube, said tube further having a plurality of transverse openings that extend across said snap groove, wherein said tube is assemblable on said intersecting bars that extend in said first direction and said transverse openings are adapted to accommodate said intersecting bars that extend in said second direction.

5. The wire mesh enclosure of claim 4, wherein said snap groove has a two edges, each edge having a protrusion that extends inward into said tube.

6. The wire mesh enclosure of claim 4, wherein said tube is made of polyvinyl chloride.

7. A bumpered lobster trap comprising:
a lobster trap constructed of a wire mesh having intersecting bars that extend in a first direction and in a second direction that intersects with said intersecting bars that extend in said first direction, said body having boundary edges; and
at least one edge protector assembled on at least one of said boundary edges, said edge protector comprising a tube having a longitudinal axis and a snap groove that extends parallel to said longitudinal axis and that splits said tube, said tube further having a plurality of transverse openings that extend across said snap groove, wherein said tube is assemblable on said intersecting bars that extend in said first direction and said transverse openings are adapted to accommodate said intersecting bars that extend in said second direction, and wherein said at least one edge protector serves as a bumper.
